(19) United States
(12) Patent Application Publication
(10) Pub. No.: US 2007/0220793 A1
(43) Pub. Date: Sep. 27, 2007

(54) Back seat passenger reminder device

(76) Inventor: Kimberley Mappes, Stoughton, WI (US)

Correspondence Address: WEST & ASSOCIATES, A PC, 2815 MITCHELL DRIVE, SUITE 209, WALNUT CREEK, CA, 94598, US

(21) Appl. No.: 11/387,591

(22) Filed: Mar. 22, 2006

(51) Int. Cl. G09F 21/04

(52) U.S. Cl. 40/593

(57) ABSTRACT

A device to remind a driver of the presence of a child or animal in the rear portion of a vehicle. A two-sided substantially planar surface includes on one side a reminder message of the presence of a child or animal in the vehicle, while the other side comprises a cut-out and/or transparent area in which a picture can be inserted. The surface is connected to a Velcro or suction-cup attachment via a connector that allows the surface to be flipped over by the driver to either view the photo or use the reminder.

### BACKGROUND

1. Field of the Invention

The present disclosure is for a device that helps drivers to remember that a child or pet is in the back of a vehicle to avoid inadvertently leaving the child or pet there, potentially with tragic results.

2. Background

Children are being forgotten in parked cars mainly for two reasons. First, they're required to ride in the back seat for safety reasons, so they're not as visible as they used to be, which leads to the “out of sight, out of mind” phenomenon. Secondly, parents and caregivers simply forget about the child's presence in the car, often due to a change in routine or even just everyday stress, such as family or work responsibilities. However, leaving a child in a car, even for a short time, can have tragic consequences.

The following statistics indicate the severity of the problem:
From 1998-2005, at least 266 children died from hyperthermia (heat stroke) after being left in a car. This number indicates only children who died; it does not include those who were rescued in time but still may have suffered serious injuries.
According to the American Academy of Pediatrics, children should never be left alone in a car, as temperatures can become deadly very quickly. For example, on a warm, sunny day, even with temperatures as mild as 60 degrees Fahrenheit, a vehicle can heat to dangerous levels in just minutes.
When children are trapped inside of cars, they may develop heat exhaustion or heat stroke, leading to permanent disability or death in a short period of time. Heat stroke can cause shock, seizures, irregular heartbeat, heart attack, and damage to the brain, liver, and kidneys.
Children are also vulnerable to injury in cold weather because their bodies don't have mechanisms for producing heat. They become hypothermic (abnormally low body temperatures) more rapidly than adults.

This problem is not limited to children. Pets are also susceptible to extreme temperatures and often left in vehicles with equally tragic results. Although pet owners are more likely to leave a pet than a child in a vehicle for a short time, a reminder to at least leave a window slightly open for ventilation could help to prevent an animal's injury or death.

Products exist that can help to remind drivers of the presence of the child or pet in the back of the vehicle. For example, rear-view mirror hangers or stickers with a message such as “look before you leave” can provide a reminder. However, these products have several drawbacks. First, a device that hangs from the rear-view mirror should be removed before driving, so as not to obscure the driver's field of vision. Therefore, it is not in the position to be seen by the driver when the car is parked, which is the critical moment at which the child or pet would be left in the car.

Devices that are permanently affixed to the rear-view mirror, dashboard, or other parts of the vehicle's interior can provide a visual reminder to the driver. For example, stickers with a reminder may be placed on the rear-view mirror. Pending U.S. patent application Ser. No. 10/697,933, filed Oct. 31, 2005 by Dang., “BABY ARERT” affixes a reminder to the middle of the dashboard, which can be “folded up when not in use”. However, seeing the reminder consistently in the same position may cause the driver to become used to it and eventually disregard it. Even though the device in Pending U.S. patent application Ser. No. 10/697,933 can be “folded up”, the driver has to remember to put it back into use. Therefore, both of these types of visual reminders can lose efficacy over a period of time.

Another type of commonly seen product is the “Baby on Board” sign and its various incarnations that have been around for several years. However, these signs are intended to alert other drivers to the presence of a child in the car so that they drive more carefully, not to look for children left behind in parked vehicles. They are designed to removably affix to an interior window of a vehicle, with the text facing outward. Therefore, these signs cannot function to remind the driver of the vehicle carrying the child that the child is in the back seat.

What is needed is a device that visually reminds drivers of the presence of a child or pet in the back seat of a vehicle that is easy to use and does not allow the driver to become too accustomed to seeing it.

### BRIEF DESCRIPTION OF THE DRAWINGS

FIG. 1 depicts a planar view of the present device before it is folded onto its functional configuration.

FIG. 2 depicts a perspective view of the present device with the reminder side visible.

FIG. 2a depicts a perspective view of the present device with the opposite picture frame side visible.

FIG. 3 depicts a method for using the present invention.

FIG. 4 depicts an embodiment of the device shown in FIG. 1.

### DETAILED DESCRIPTION

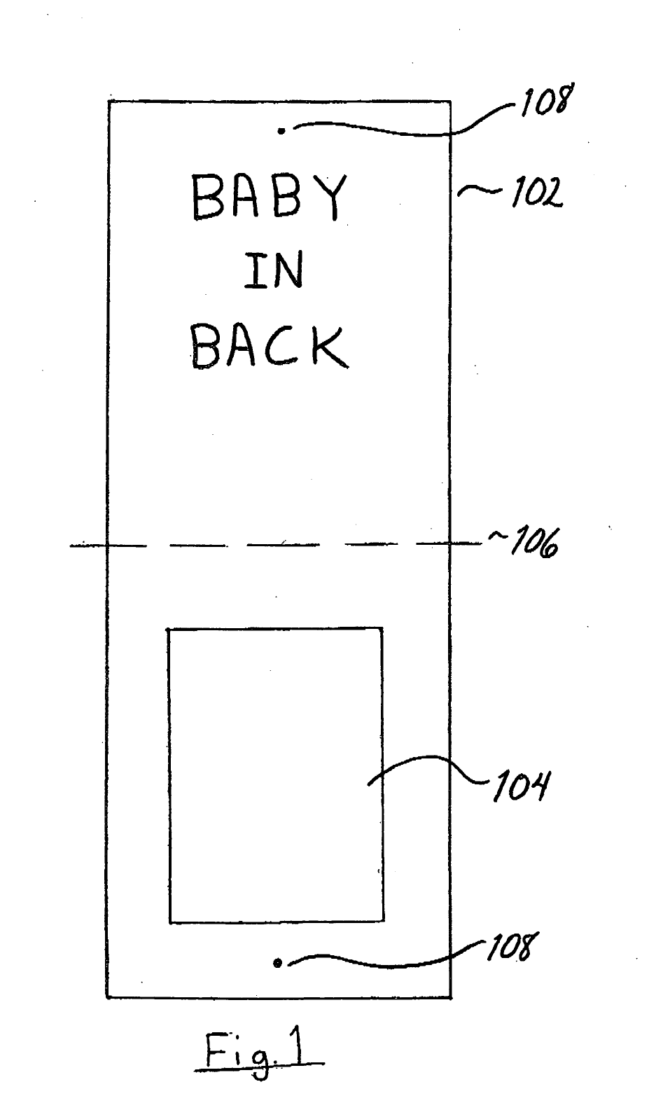

FIG. 1 depicts a planar view of an embodiment of the present device before it is folded into its functional configuration. In the embodiment shown, a substantially planar piece of material 102, such as, but not limited to cardboard or plastic, can be cut to have a rectangular exterior border, with an opening 104 cut into the planar piece of material substantially near one end of the piece 102. Alternatively, another embodiment could use a non-planar piece of material that would have more thickness than the embodiment shown here. Although shown here in a rectangular configuration, the exterior border can be cut to any desired or convenient shape. It may be cut, as in the depicted embodiment, such that when the planar piece of material is folded substantially along its longitudinal midline 106 to form a “folder”, where the exterior edges substantially align. Alternatively, there may be an embodiment in which separate pieces form the folder, rather than a continuous piece. In some embodiments, the sides of the “folder” can be attached with any known or convenient fasteners or adhesives, or can be formed together.

In alternate embodiments, the device can be formed from a single piece of material, which, when split along the midline of its thickness, forms a folder. The opening 104 may be cut to any desired shape to provide a frame for a picture. A hole 108 can cut into both ends of the planar piece of material such that when it is folded over the holes 108 will align to receive a connecting member that joins the planar piece of material to another member, such as, but not limited to, a hook-and-loop patch (Velcro®), adhesive patch, or suction cup. Alternatively any connecting member may be affixed directly to the surface of the planar piece of material.

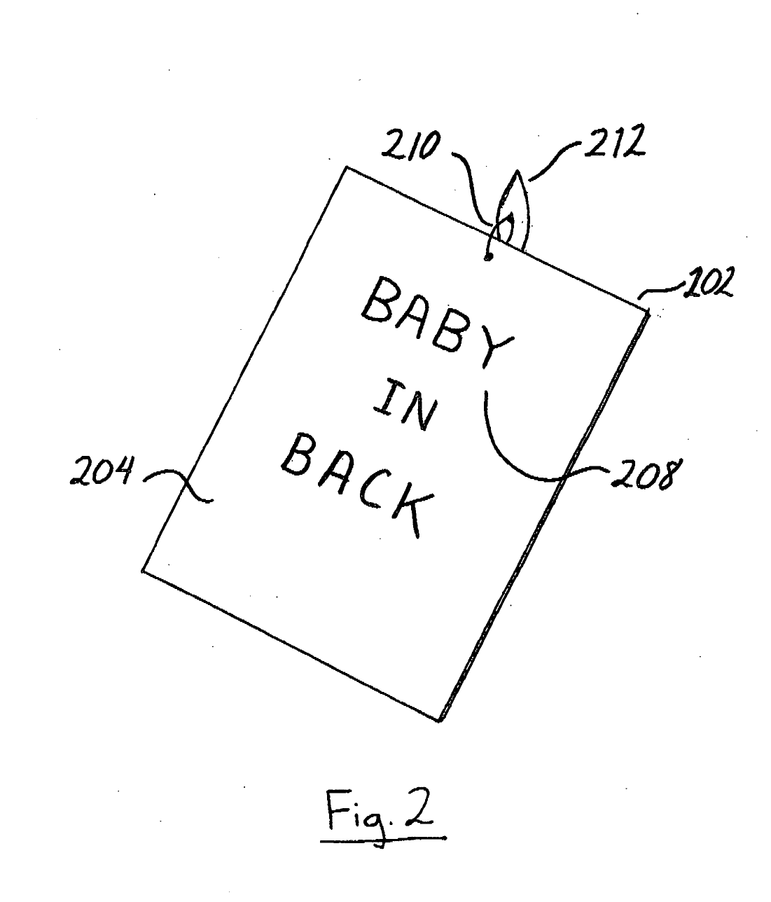

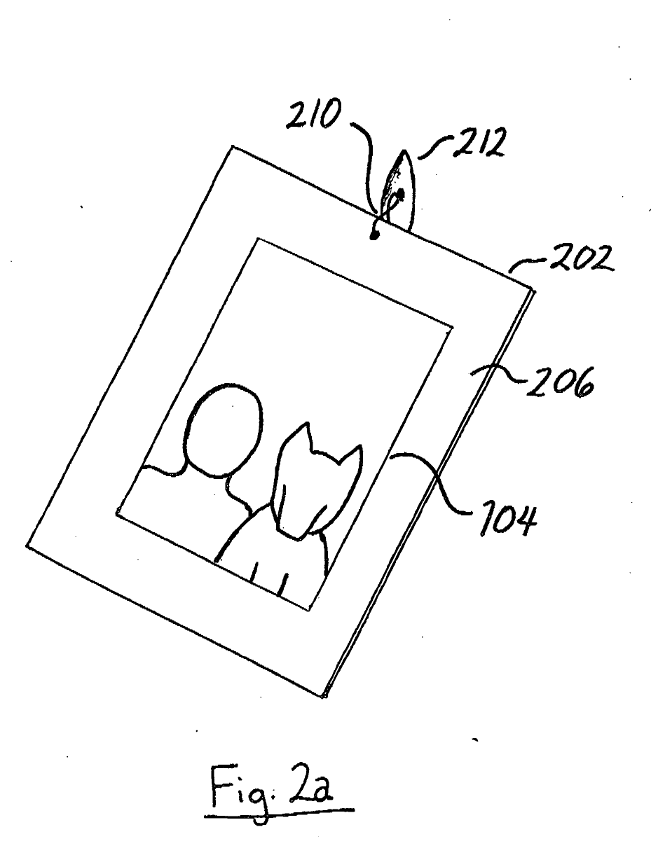

FIG. 2 depicts a perspective view of the current device, after it has been folded into its functional configuration. The planar surface 102 can be folded substantially along its longitudinal midline to form a “folder” or “pocket” 202 having an obverse surface 204 and a reverse surface 206. Alternatively, a single sheet of material may be split substantially along the midline of its thickness to form a “pocket”. On the surface with the opening 104 cut into it a picture can be inserted via an unsealed edge of the folder 202 such that it shows through the opening 104.

In alternate embodiments, the device can be fashioned without an opening 104. In such embodiments, a picture could be affixed directly to a surface with any commonly known or used fastener or adhesive. The opposite surface can contain a reminder 208 that a child, animal or other occupant and/or object is in the car. This reminder may be textual, symbolic, or any other convenient or known means of communication.

In some embodiments, a connecting member 210 can be inserted through the hole to connect the planar piece of material to another member that affixes the device to a portion of the vehicle. The connecting member 210, is depicted in the present embodiment as a flexible cord, which can extend through the holes and can connect the folder 202 to a hook-and-loop patch, adhesive patch, suction cup, or any other convenient or known means of affixing the device to the dashboard or other area of the vehicle 212.

In alternate embodiments, the connecting member 210 can be any other known or convenient means that allows the planar piece of material to be flipped over and be disengageably coupled with the planar piece of material without the need for holes 108.

To use the device, a driver can affix the device to the dashboard or other convenient area of a vehicle where it can be easily seen, yet not distract the driver. If a child or animal is not present in the vehicle, the driver can flip the folder 202 such that the side with the framed picture is visible. When a child or animal is present in the vehicle, perhaps in the rear area and not in immediate sight of the driver, the driver can flip the folder 202 such that the reminder 208 is now visible to said driver. When the driver reaches their destination, the driver can see the visual reminder 208 and thus should not inadvertently leave the child or animal in the car.

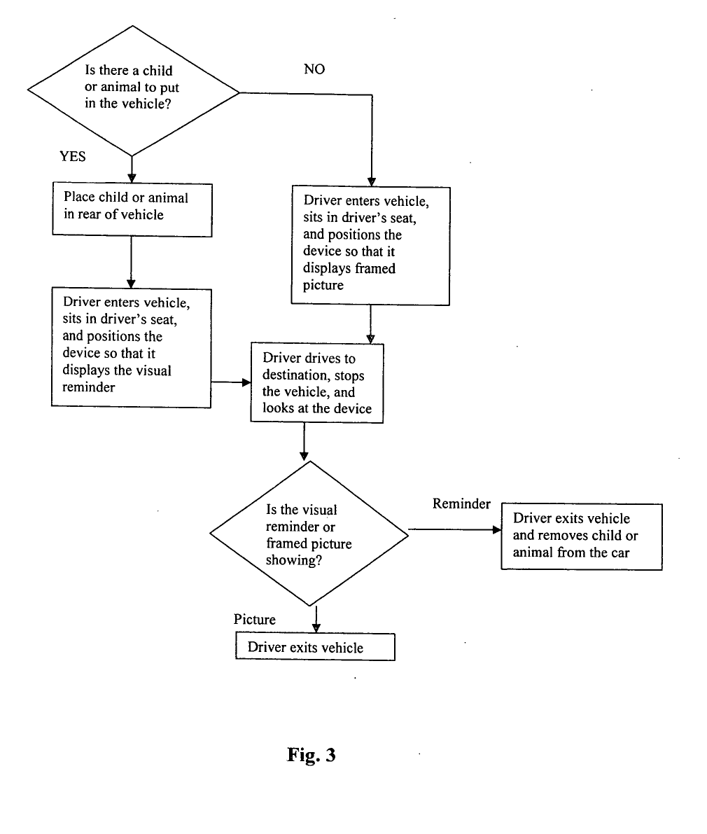

FIG. 3 shows the steps for the method of using the present device. If a child or animal is a passenger for the ride, the driver places the child or animal in the back seat of the car, and then enters the driver's seat. The driver then looks at the folder 202 and flips it to the side containing the appropriate visual reminder 208. Upon reaching a destination, the driver looks at the folder, sees the visual reminder 208 side displayed, exits the vehicle himself, and removes the other passenger from the vehicle. If no child or animal passengers were present when he entered the vehicle himself, he would have set the folder with the framed picture side displayed. Upon reaching a destination, he would look at the folder 202 and be reminded that no child, animal passenger, occupant and/or object was present in the vehicle at this time.

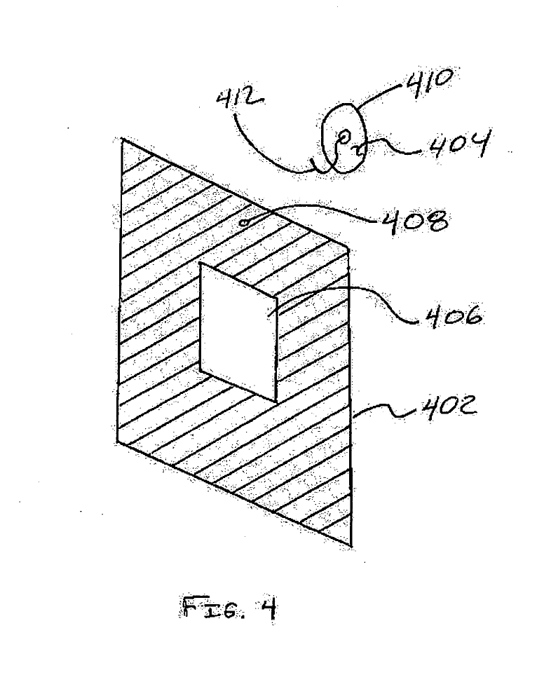

FIG. 4 depicts an alternate embodiment of the device shown in FIG. 1. The device shown in FIG. 4 includes a planar panel 402 and a securing mechanism 404. The planar panel 402 includes an image region 406 and an aperture 408.

In the embodiment shown in FIG. 4, the planar panel 402 can be comprised, at least in part, of clear plastic. Additionally, in some embodiments the planar panel 402 can be at least partially opaque, except in the image region 406. In alternate embodiment, the planar panel 402 can be partially opaque, completely opaque and/or transparent in any convenient locations within the planar panel 402.

In some embodiments, the planar panel 402 can be comprised of any known and/or convenient material. Additionally in some embodiments, the planar panel 402 can be comprised of a material which can be selectively imprinted and/or marked by a user using any known and/or convenient marking and/or imprinting method and/or mechanism. In alternate embodiments, the planar panel 402 can be pre-printed and the image region 406 can be selectively imprinted and/or marked by a user.

In some embodiments, the image region 406 can be transparent, opaque and/or partially opaque in any convenient locations within the image region 406.

In the embodiment shown in FIG. 4, the aperture 408 can be adapted to secure the planar panel 402 to a surface. In the embodiment shown in FIG. 4, the securing mechanism 404 is comprised of a suction cup 410 coupled with a hook 412. In the embodiment shown in FIG. 4, the suction cup 410 is adapted to selectively couple with the windshield and/or mirror of a vehicle and the hook 412 is adapted to selectively mate with the aperture 408 in at least two positions. In a first position, one side of the planar surface 402 can be visible from the interior of a vehicle and in a second position, the opposing side of the planar surface 402 can be visible from the interior of the vehicle.

In some embodiments, one side of the planar surface can include a visual indicator of the presence of at least one individual, at least one animal and/or at least one item in the passenger compartment or rear of a vehicle. Additionally, the second side of the planar surface 402 can include an alternate image. In some embodiments, the visual indicator and/or alternate image can be at least partially located within the image region 406. However in alternate embodiments, the visual indicator and/or alternate image can be located in any convenient location on the planar surface 402.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A device to remind a driver of the presence of an occupant or property in the vehicle, comprising:
at least one substantially planar piece of material having a first surface and a second surface;
a connecting member having a proximal end and a distal end, said distal end being detachably couplable with the planar piece of material; and
a base member connected to said proximal end of said connecting member, wherein said base member is disengagably couplable with a vehicle interior.

2. The device of claim 1, wherein said first surface has an opening cut therein, said opening adapted to frame an inserted picture;
and wherein the second surface displays an indicator that at least one of a person, animal and property is present in the vehicle.

3. The device of claim 2, wherein said indicator is at least one of the group consisting of: text, symbolic images, or colors.

4. The device of claim 1, comprising:
at least two substantially planar pieces of material;
wherein one of said substantially planar pieces of material includes an opening cut into a surface;
wherein a surface of a second of said substantially planar pieces of material includes an indicator that at least one of a person, animal or property is present in the vehicle; and
wherein said pieces are joined together, such that one surface displays the indicator and another surface displays the opening.

5. The device of claim 4, wherein said indicator is at least one of the group consisting of: text, symbolic images, or colors.

6. The device of claim 1, wherein:
said at least one substantially planar piece of material has a thickness; and further comprising:
at least one penetration in said first surface;
at least one opening in said thickness; and
a path coupling said at least one penetration and said at least one opening.

7. The device of claim 6 wherein an indicator is present in said at least one penetration.

8. The device of claim 7, wherein said reminder is at least one of the group consisting of: text, symbolic images, or colors.

9. The device of claim 1, wherein said base member is a suction cup.

10. The device of claim 1, wherein said base member is a hook-and-loop patch.

11. The device of claim 1, wherein said base member is an adhesive patch.

12. The device of claim 1, wherein said connecting member is a flexible cord.

13. A device for providing visual indicators comprising:
a transparent panel having a first surface and a second surface;
a penetration extending through said first surface and said second surface;
markings on said first surface defining a first image region;
markings on said second surface defining a second image region; and
an attachment mechanism adapted to engage said penetration and selectively couple said panel with a third surface in at least two orientations;
wherein said first image region is adapted to receive a first visual indicator; and
wherein said second image region is adapted to receive a second visual indicator.

14. The device of claim 13 wherein said attachment mechanism is comprised of a suction cup coupled with a hook.

15. The device of claim 14 wherein said first visual indicator is at least one of the group consisting of text, symbolic images, or at least one color.

16. The device of claim 15 wherein said second visual indicator is at least one of the group consisting of text, symbolic images, or at least one color.
